(19) United States
(12) Patent Application Publication
(10) Pub. No.: US 2026/0239358 A1
(43) Pub. Date: Aug. 13, 2026

(54) SYMBOL TYPE AND CONFIGURATION FOR UL MUTING

(71) Applicant: QUALCOMM Incorporated, San Diego, CA (US)

(72) Inventors: Qian ZHANG, Basking Ridge, NJ (US); Muhammad Sayed Khairy ABDELGHAFFAR, San Jose, CA (US)

(21) Appl. No.: 19/325,221

(22) Filed: Sep. 10, 2025

Related U.S. Application Data
(60) Provisional application No. 63/755,858, filed on Feb. 7, 2025.

(51) Int. Cl. H04W 72/21; H04L 5/00; H04L 5/14

(52) U.S. Cl. CPC H04W 72/21; H04L 5/0005; H04L 5/143

(57) ABSTRACT

Apparatus, methods, and computer program products for wireless communication are provided. An example method may include receiving, from a network node, an indication of whether at least one SBFD configuration associated with the network node is a configuration type I or a configuration type II, where the configuration type I is associated with a communication being based on one type of at least one SBFD symbol or at least one non-SBFD symbol without another type, and where the configuration type II is associated with the communication being based on the at least one SBFD symbol and the at least one non-SBFD symbol. The example method may further include transmitting, to the network node based on uplink resource muting, a PUSCH transmission, where the uplink resource muting is applied to the at least one SBFD symbol or the at least one non-SBFD symbol of the PUSCH transmission based on the indication.

### CROSS REFERENCE TO RELATED APPLICATION(S)

This application claims the benefit of and priority to U.S. Provisional Application Ser. No. 63/755,858, entitled “SYMBOL TYPE AND CONFIGURATION FOR UL MUTING” and filed on Feb. 7, 2025, which is expressly incorporated by reference herein in its entirety.

### TECHNICAL FIELD

The present disclosure relates generally to communication systems, and more particularly, to wireless communication systems with uplink resource muting.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may include at least one memory and at least one processor coupled to the at least one memory. Based at least in part on information stored in the at least one memory, the at least one processor, individually or in any combination, is configured to (e.g., cause the UE to) receive, from a network node, an indication of whether at least one sub-band full duplex (SBFD) configuration associated with the network node (and/or the UE) is associated with a configuration type I or a configuration type II, where the configuration type I is associated with a communication being based on one type of at least one SBFD symbol or at least one non-SBFD symbol without another type, and where the configuration type II is associated with the communication being based on the at least one SBFD symbol and the at least one non-SBFD symbol. Based at least in part on information stored in the at least one memory, the at least one processor, individually or in any combination, is configured to transmit, to the network node based on an uplink resource muting, a physical uplink shared channel (PUSCH) transmission, where the uplink resource muting is applied to the at least one SBFD symbol or the at least one non-SBFD symbol of the PUSCH transmission based on the indication.

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network, in accordance with various aspects of the present disclosure.

FIG. 4 is a diagram illustrating example full duplex at a network entity, in accordance with various aspects of the present disclosure.

FIG. 5 is a diagram illustrating example subband full duplex, in accordance with various aspects of the present disclosure.

FIG. 6 is a diagram illustrating example crosslink interference (CLI), in accordance with various aspects of the present disclosure.

FIG. 7 is a diagram illustrating example CLI, in accordance with various aspects of the present disclosure.

FIG. 8A is a diagram illustrating example configuration type I, in accordance with various aspects of the present disclosure.

FIG. 8B is a diagram illustrating example configuration type II, in accordance with various aspects of the present disclosure.

FIG. 9 is a diagram illustrating example communications between a network node and a UE, in accordance with various aspects of the present disclosure.

FIG. 10 is a flowchart of a method of wireless communication, in accordance with various aspects of the present disclosure.

FIG. 11 is a diagram illustrating an example of a hardware implementation for an example apparatus and/or network entity, in accordance with various aspects of the present disclosure.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

In some wireless communication systems, for physical uplink shared channel (PUSCH) repetition type A in sub-band full duplex (SBFD) symbols with configuration type I, the same time location of none, one or two uplink (UL) muting symbol(s) may be applied for all PUSCH repetitions. For PUSCH repetition type B in SBFD symbols with configuration type I, the same time location of none, one or two UL muting symbol(s) per slot is applied for all the actual PUSCH repetitions. Aspects provided herein provide additional mechanisms regarding whether to apply/how to apply UL muting (which may also be referred to as “UL resource muting”) on non-SBFD symbols. Aspects provided herein also provide whether to apply/how to apply UL muting for configuration type II. Aspects provided herein may enable more efficient UL muting for mitigating CLI for wireless communication systems.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof. One or more processors in the processing system may execute software to cause a device that includes the one or more processors to perform the various functionality described throughout this disclosure.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer (e.g., transitory or non-transitory medium that may be accessed by computer).

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

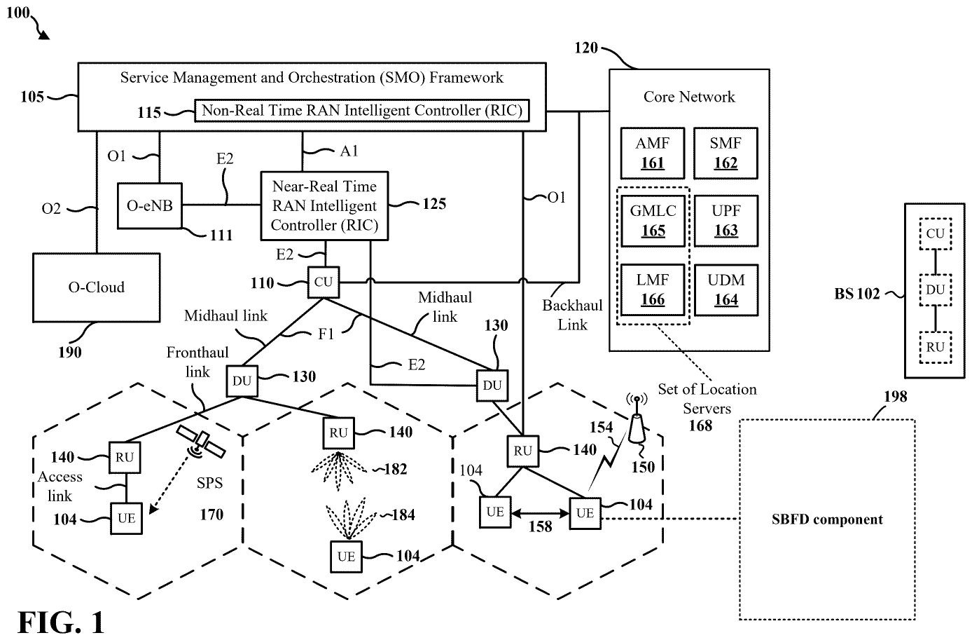

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include an SBFD component 198. In some aspects, the SBFD component 198 may be configured to receive, from a network node, an indication of whether at least one sub-band full duplex (SBFD) configuration associated with the network node (e.g., and/or the UE) is associated with a configuration type I or a configuration type II, where the configuration type I is associated with a communication being based on one type of at least one SBFD symbol or at least one non-SBFD symbol without another type, and where the configuration type II is associated with the communication being based on the at least one SBFD symbol and the at least one non-SBFD symbol. In some aspects, the SBFD component 198 may be further configured to transmit, to the network node based on an uplink resource muting, a physical uplink shared channel (PUSCH) transmission, where the uplink resource muting is applied to the at least one SBFD symbol the at least one non-SBFD symbol of the PUSCH transmission based on the indication.

Although the following description may be focused on 5G NR, the concepts described herein may be applicable to other similar areas, such as LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

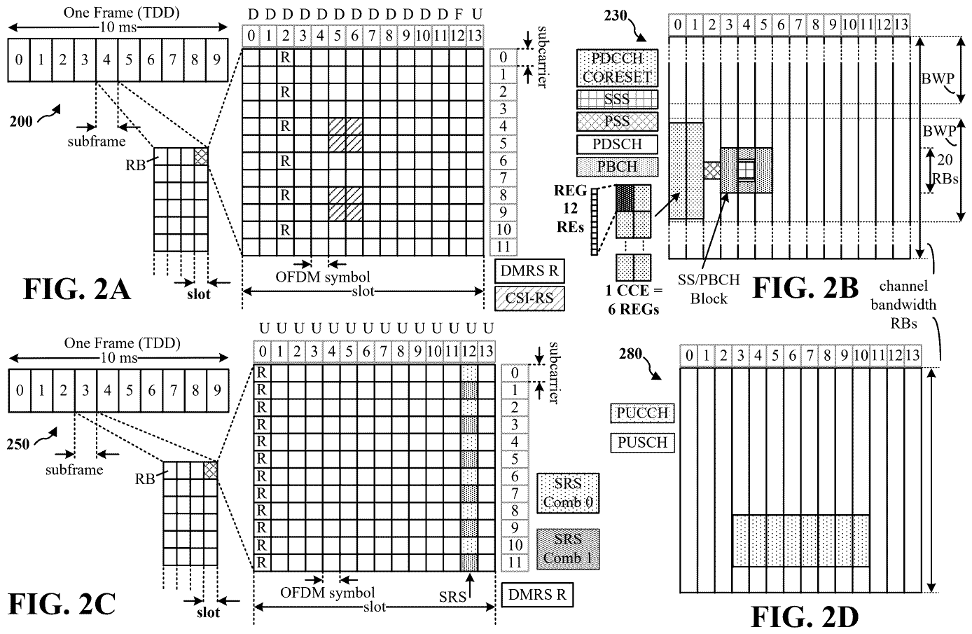

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 24 slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

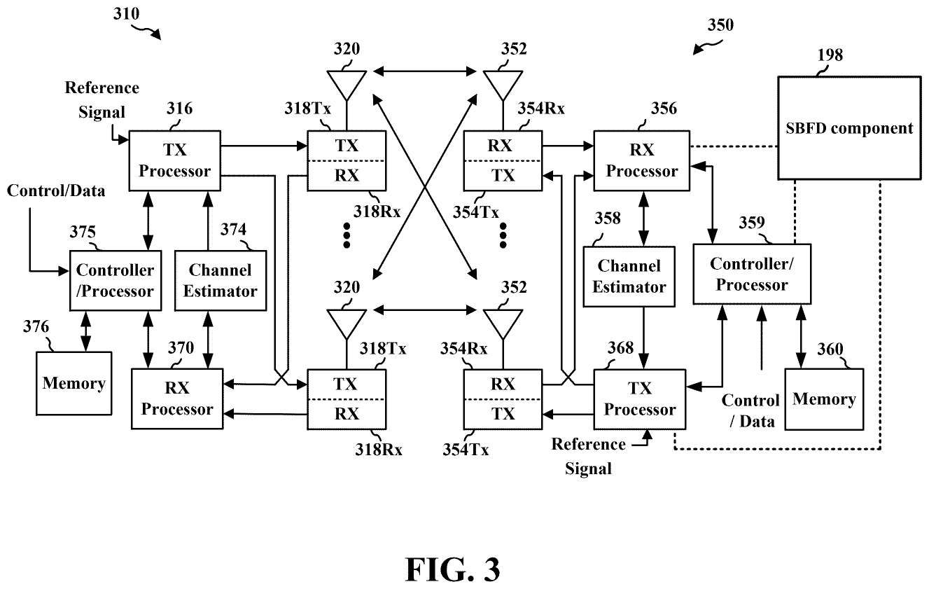

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with SBFD component 198 of FIG. 1.

In some wireless communication systems, full duplex (FD) capability (supporting simultaneous UL or DL transmission) may be present at a base station, a UE, or both the base station and the UE. For example, at the UE, UL transmissions may be transmitted from a first panel of the UE while simultaneous DL receptions may be received at a second panel of the UE. The first panel and the second panel may be different panels of the antenna(s) on the UE. As another example, at the base station, UL receptions may be received from a first panel of the base station while simultaneous DL transmissions may be transmitted at a second panel of the base station. The first panel and the second panel may be different panels of the antenna(s) on the base station. By supporting FD, latency of communications may be potentially reduced. For example, it may be possible for a UE to receive DL signal in slots assigned for UL, which may enable latency savings. Furthermore, by supporting FD, spectrum efficiency per cell and per UE may be improved because resource utilization over the spectrum may be more efficient.

Subband (SB) non-overlapping full duplex and dynamic/flexible time division duplex (TDD) may be used in wireless communication systems to enhance spectrum efficiency and enhance throughput by dynamically altering UL or DL transmission direction. However, inter-network entity and inter-UE crosslink interference (CLI), which may be intra-subband CLI or inter-subband CLI may occur. A victim UE or a victim network entity may receive transmissions not targeted to the victim from an aggressor UE or an aggressor network entity. For example, CLI may occur when a UL/DL symbol from the aggressor collides with a UL/DL symbol of the victim.

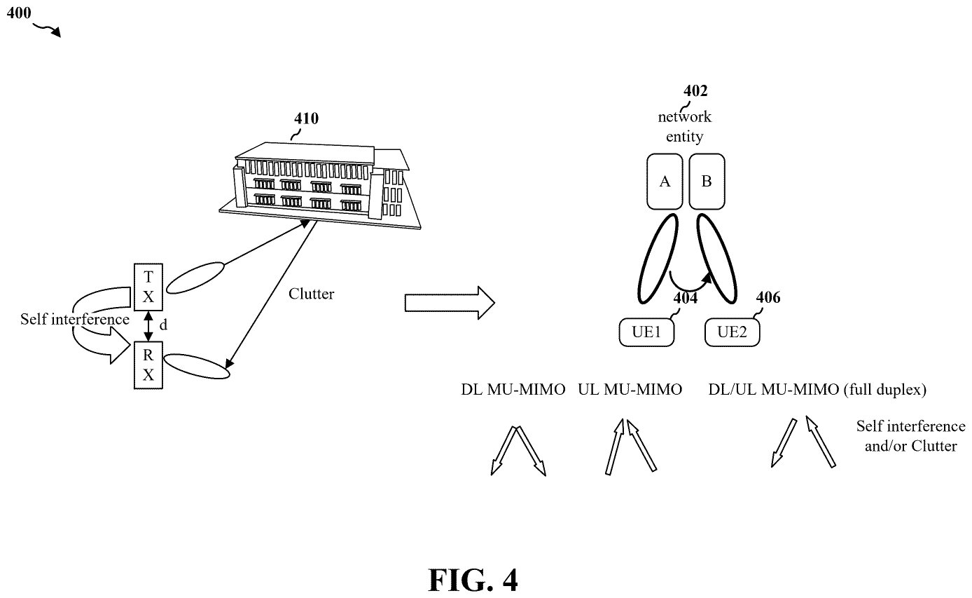

FIG. 4 is a diagram 400 illustrating example full duplex at a network entity. As illustrated in FIG. 4, at a network entity 410, there may be self-interference between Tx and Rx at the network entity 410 due to simultaneous Tx and Rx operations. Similarly, at a network entity 402, the network entity 402 may be in communication with a UE 404 and a UE 406. In some aspects, the network entity 402 may simultaneously transmit to both the UE 404 and the UE 406. In some aspects, the network entity 402 may simultaneously receive from both the UE 404 and the UE 406. With full duplex, the network entity 402 may simultaneously transmit to the UE 404 and receive from the UE 406, and self-interference or clutter between the transmission and the reception may occur.

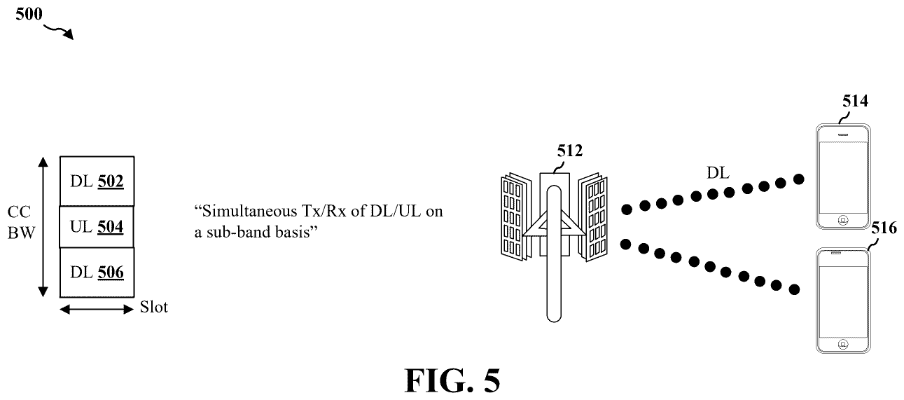

FIG. 5 is a diagram 500 illustrating example subband full duplex (SBFD). In subband full duplex, transmission resources (e.g., DL resource 502 and DL resource 506) and reception resources (e.g., UL resource 504) may overlap in time using different frequencies. A base station 512 may transmit to UE 514 using DL resource 502 and DL resource 506 while receiving from UE 516 using UL resource 504. In contrast, in-band full-duplex (IBFD) may be based on transmitting and receiving in resources overlapping in time and overlapping in frequency. By using SBFD, UL duty cycle may be increased which may lead to latency reduction (e.g., it is possible to receive DL signal in UL slots, which can enable latency savings) and UL coverage improvement, enhanced system capacity/resource utilization/spectrum efficiency, and enable flexible and dynamic UL/DL resource adaption according to UL/DL traffic in a robust manner. In some wireless communication systems, SBFD may be deployed at a network node while the UE is still operating in a half-duplex mode.

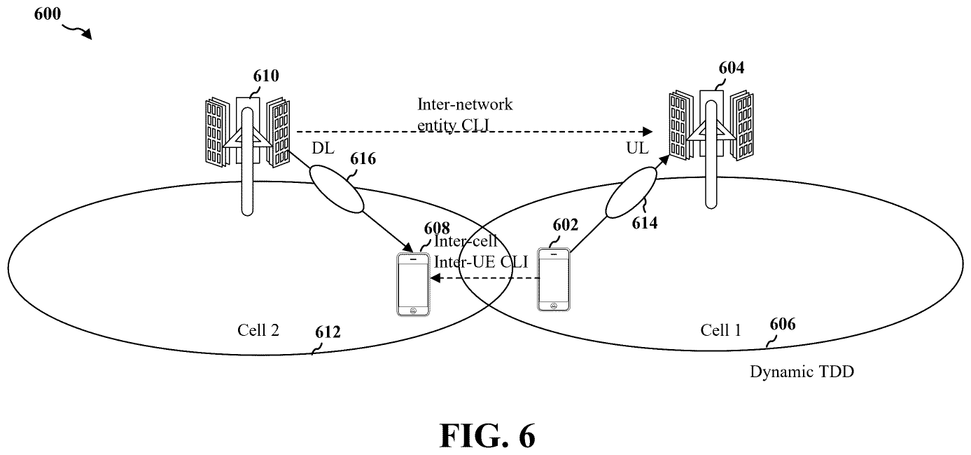

FIG. 6 is a diagram 600 illustrating example CLI. A first UE 602 may be within a first cell 606 and served by a first network entity 604 and a second UE 608 may be within a second cell 612 and served by a second network entity 610. CLI may occur between UEs at the cell edges of nearby cells, as UEs at cell edges of nearby cells may be in close proximity to each other. As illustrated in FIG. 6, the first UE 602 and the second UE 608 are respectively at cell edge of the first cell 606 and the second cell 612. The first UE 602 and the second UE 608 may be respective communication with the first network entity 604 and the second network entity 610. For example, the first UE 602 may transmit a UL transmission 614 to the first network entity 604 while the second UE 608 receives a DL transmission 616 from the second network entity 610. In some aspects, the UL transmission 614 to the first network entity 604 may also be received by the second UE 608, which may cause inter-UE CLI. As such, at the second UE 608, one or more symbols of the UL transmission 614 may collide with one or more symbols of the DL transmission 616. In addition to inter-UE CLI, inter-network entity CLI may also occur. For example, the first network entity 604 may receive the DL transmission 616 while receiving the UL transmission 614. As such, at the first network entity 604, one or more symbols of the UL transmission 614 may collide with one or more symbols of the DL transmission 616. The first network entity 604 may be referred to as a “victim network entity” because the first network entity 604 may be receiving a transmission not intended to be received by the first network entity 604 that interferes with a transmission that is intended to be received by the first network entity 604. Similarly, the second UE 608 may be referred to as a “victim UE.” The second network entity 610 may be referred to as an “aggressor network entity” because a transmission from the second network entity 610 may cause CLI to another network entity. Similarly, the first UE 602 may be referred to as an “aggressor UE.” Aspects provided herein may provide mechanisms for reducing inter-UE CLI for full duplex operations, increasing overall efficiency and throughput of the communication system.

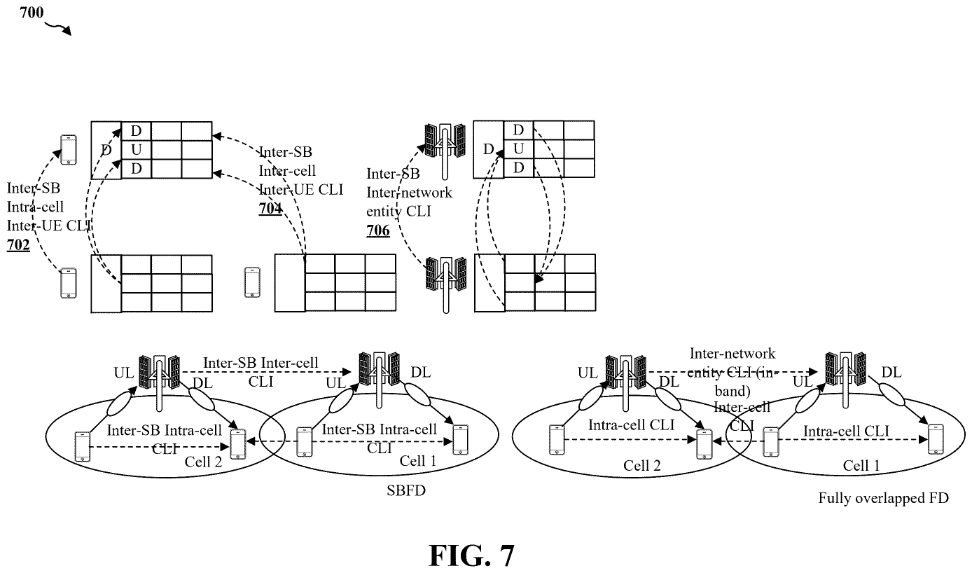

FIG. 7 is a diagram 700 illustrating example CLI. As illustrated in FIG. 7, CLI may be within a same cell or in different cells (intra-cell or inter-cell), within a same SB or in different SBs (intra-SB or inter-SB), between UEs (inter-UE) or between network entities (inter-network entity which may be otherwise referred to as inter-gNB). For example, in a communication system, there may be inter-SB, intra-cell, inter-UE CLI 702. There may also be inter-SB, inter-cell, and inter-UE CLI 704. There may also be inter-SB inter-network entity CLI 706.

Enhancements for CLI handling in SBFD-enabled systems may be implemented through various mechanisms, such as exchange of SBFD configuration information and UL resource muting for PUSCH. As used herein, the term “uplink resource muting” refers to a mechanisms where a UE would restrict or disable uplink transmissions on specified time/frequency resources for interference management purposes. For example, if UL resource muting is applied on a symbol for a PUSCH, the UL resource muting may be applied to a number of PRBs of all of the allocated PRBs of the PUSCH on that symbol based on a pattern, such as a comb-2 pattern (a pattern where every second PRB may be subject to muting, which would be an alternating pattern). As an example, for the reference point of time location of UL resource muting for PUSCH, a starting symbol of a slot for both PUSCH mapping type A or PUSCH mapping type B may be used. As an example, to determine the time location of UL muting symbol(s) in a slot for a PUSCH, the time location for each of one or two UL muting symbols may be configured (e.g., semi-statically), and muting the configured time location of UL muting symbol(s) (which may be zero, one, or two) may be dynamically turned on or turned off based on time domain resource allocation (TDRA) field of downlink control information (DCI) associated with the PUSCH. For exchange of SBFD configuration information, semi-static cell-specific time and frequency location configuration associated with SBFD may be exchanged between network entities. Measurement resource configuration, including SSB or periodic non-zero power channel state information reference signals (NZP CSI-RS), may be exchanged to facilitate interference management. Information related to the strongest downlink (DL) beam may be exchanged to improve CLI mitigation strategies. A CLI-mitigation request may be exchanged between network nodes. Regarding UL resource muting for PUSCH, UL resource muting for PUSCH may be determined based on a semi-static configuration, a comb-2 structure may be applied for both discrete Fourier transform spread orthogonal frequency division multiplexing (DFT-S-OFDM) and cyclic prefix-OFDM (CP-OFDM) within each allocated PRB. As an example, the muting may be applied for up to two symbols in the time domain.

PUSCH resource mapping may be configured to perform rate-matching around the muted REs. Uplink control information (UCI) resource determination may be performed for symbols containing muted REs. As an example, UL resource muting may be applicable to UEs in RRC connected mode. As an example, the UE may assume that the UL resource muting pattern does not overlap with UL DM-RS or phase tracking reference signals (PT-RS) within the same symbol. Power boosting may be applied to other REs within the symbol where UL resource muting is applied, where the total PUSCH transmit power remains unchanged across symbols.

As an example, for PUSCH repetition type A in SBFD symbols with Configuration 1, the same time location of none, one or two UL muting symbol(s) is applied for all PUSCH repetitions. For PUSCH repetition type B in SBFD symbols with Configuration 1, the same time location of none, one or two UL muting symbol(s) per slot is applied for all the actual PUSCH repetitions. PUSCH repetition type A is a repetition scheme where the transmission instances of the PUSCH are mapped to different slots while maintaining the same frequency and time-domain resource allocation in each repetition. PUSCH repetition type B is a repetition scheme where the repeated PUSCH transmissions may be mapped to different frequency or time-domain resources, which introduces more flexibility compared to PUSCH repetition type A.

For UL transmissions and DL receptions across SBFD symbols and non-SBFD symbols in different slots (each transmission/reception within a slot has either all SBFD or all non-SBFD symbols) for an SBFD aware UE, the SBFD-aware UE is provided with one of the configurations that may be referred to as configuration type I or configuration type II. For configuration type I, the transmissions/receptions are restricted to SBFD symbols (without non-SBFD symbols) or non-SBFD symbols (without SBFD symbols). For configuration type II, the transmissions/receptions may be in SBFD symbol(s) and/or non-SBFD symbol(s).

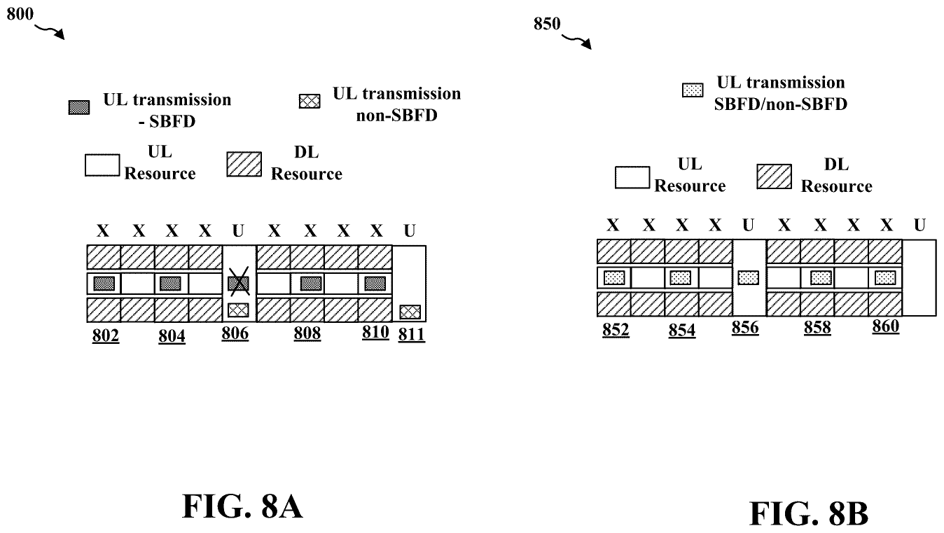

FIG. 8A is a diagram 800 illustrating example configuration type I, in accordance with various aspects of the present disclosure. As illustrated in FIG. 8A, based on configuration type I, the UL transmissions may be in SBFD symbols, including SBFD symbol 802, SBFD symbol 804, SBFD symbol 808, and SBFD symbol 810. If the UL transmissions are in SBFD symbols, there may be no UL transmission in non-SBFD symbol 806. Based on configuration type I, the UL transmissions may be in non-SBFD symbols as well, including non-SBFD symbol 806 and non-SBFD symbol 811.

However, there may be no mix-and-match of SBFD symbols and non-SBFD symbols for UL transmission.

FIG. 8B is a diagram 850 illustrating example configuration type I, in accordance with various aspects of the present disclosure. As illustrated in FIG. 8B, based on configuration type I, the UL transmissions may be in both SBFD symbols or non-SBFD symbols, including SBFD symbol 852, SBFD symbol 854, non-SBFD symbol 856, SBFD symbol 858, and SBFD symbol 860.

In some wireless communication systems, for PUSCH repetition type A in SBFD symbols with configuration type I, the same time location of none, one or two UL muting symbol(s) may be applied for all PUSCH repetitions. For PUSCH repetition type B in SBFD symbols with configuration type I, the same time location of none, one or two UL muting symbol(s) per slot is applied for all the actual PUSCH repetitions. Aspects provided herein provide additional mechanisms regarding whether to apply/how to apply UL muting (which may also be referred to as “UL resource muting) on non-SBFD symbols, such as in dynamic TDD scenarios. Aspects provided herein also provide whether to apply/how to apply UL muting for configuration type II. Aspects provided herein may enable more efficient UL muting for mitigating CLI for wireless communication systems.

In some aspects, UL resource muting may be applied to PUSCH transmissions to a network node of configuration type I (network node associated with configuration type I). In some aspects, UL resource muting may be applied to PUSCH transmissions to a network node of configuration type II (network node associated with configuration type II). In some aspects, UL resource muting may be applied to PUSCH transmissions to a network node of configuration type I or configuration type II. In some aspects, UL resource muting may be applied to SBFD symbols, without being applied to non-SBFD symbols. In some aspects, UL resource muting may be applied to configuration type I that the transmissions/receptions are restricted to SBFD symbols without non-SBFD symbols. In such scenarios, for UL resource muting, the valid symbol type for UL resource muting is SBFD symbol (e.g., without non-SBFD symbol).

In some aspects, UL resource muting may apply to configuration type I where the transmissions/receptions are in one of SBFD symbols or non-SBFD symbols without the other, without (not allowed to) being applied to configuration type II. In some aspects, UL resource muting may apply to one (e.g., and no more than one) of SBFD symbols or non-SBFD symbols. There may be an indication of symbol type in a UL resource muting information element (IE) in a UL resource muting configuration to indicate the type of symbol that the UL resource muting may be applied to. The indication may be transmitted from the network node to the UE.

In some aspects, UL resource muting may apply to configuration type II where the transmissions/receptions may be in SBFD symbols or non-SBFD symbols, without (not allowed to) being applied to configuration type I. In some aspects, UL resource muting may apply to SBFD symbols or non-SBFD symbols. A UL muting pattern may be defined without signaling or communicated between a network node and a UE. For example, in some aspects, a single UL muting time and frequency pattern may be configured so that the frequency location follows on the PUSCH frequency allocation and frequency offset on SBFD and non-SBFD symbols. In some aspects, two UL muting time and frequency patterns may be separately configured for SBFD and non-SBFD symbols. The two UL muting time and frequency patterns may have a same pattern, or different patterns.

In some aspects, configuration type I may be applicable to UL resource muting without additional capability indication. In some aspects, the UE may indicate, in a capability reporting, whether UL resource muting may be supported when configuration type II is configured. In some aspects, if UL resource muting is supported when configuration type II is configured, two UL muting time and frequency patterns may be separately configured for SBFD and non-SBFD symbols.

In some aspects, for a slot with mixed SBFD and non-SBFD symbols, when UE is provided with configuration type II (e.g., indicated by the network node that network node is associated with) and two UL-RM patterns, each pattern may be applied separately to a corresponding subset of the symbols in the slot, based on the associated symbol type (e.g., SBFD or non-SBFD). For example, if symbol 0-9 SBFD and symbol1 10-13 non-SBFD, then SBFD UL resource muting pattern is applied to symbols 0-9 and non-SBFD UL resource muting pattern is applied to symbol 10-13. As another example, referring back to FIG. 8B, the SBFD UL resource muting pattern is applied to the SBFD symbol 852, the SBFD symbol 854, the SBFD symbol 858, and the SBFD symbol 860. The non-SBFD UL resource muting pattern is applied to non-SBFD symbol 856.

In some aspects, if UE is provided with configuration type I and a single UL resource muting pattern (e.g., an SBFD UL resource muting pattern), then the UL resource muting pattern is applicable to the set of symbols in the slot of the same duplex type.

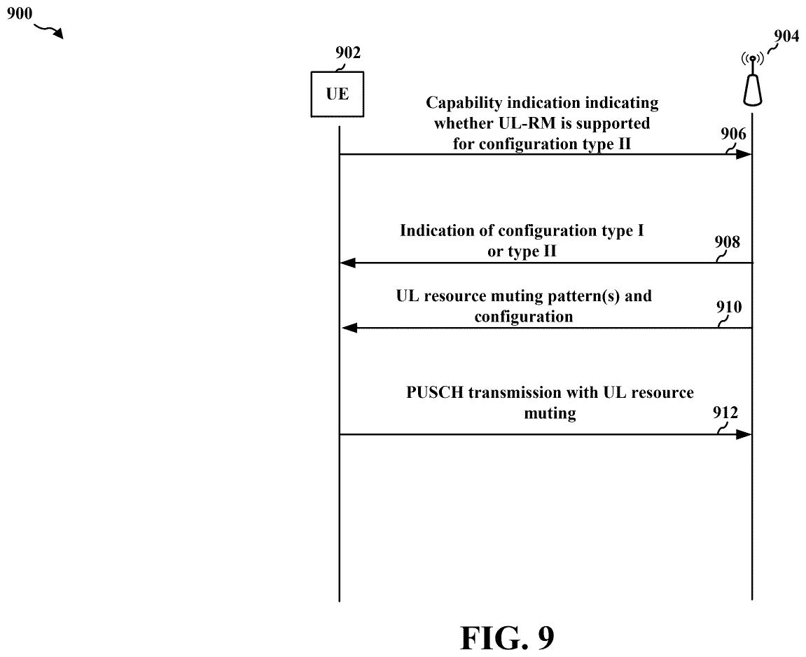

FIG. 9 is a diagram 900 illustrating example communications between a network node 904 and a UE 902, in accordance with various aspects of the present disclosure. In some aspects, the network node 904 may indicate, to the UE 902 at 908, whether configuration type I or configuration type II is configured. The network node 904 may also transmit a UL resource muting configuration 910 to the UE 902, which includes a single UL resource muting pattern for all symbol types or separate UL resource muting patterns for different symbol types. In some aspects, based on whether configuration type I or configuration type II is configured and based on the UL resource muting configuration 910, the UE 902 may transmit PUSCH transmission 912 with UL resource muting to the network node 904.

In some aspects, UL resource muting may be applied to the PUSCH transmission 912 when configuration type I is indicated at 908. In some aspects, UL resource muting may be applied to the PUSCH transmission 912 when configuration type I is indicated at 908. In some aspects, UL resource muting may be applied to the PUSCH transmission 912 in either scenario. In some aspects, UL resource muting may be applied to SBFD symbols in the PUSCH transmission 912, without being applied to non-SBFD symbols in the PUSCH transmission 912. In some aspects, UL resource muting may be applied to configuration type I and if the PUSCH transmission 912 uses SBFD symbols without non-SBFD symbols. In such scenarios, for UL resource muting configuration 910, the indicated valid symbol type for UL resource muting is SBFD symbol (e.g., without non-SBFD symbol).

In some aspects, UL resource muting may apply to configuration type I where the PUSCH transmission 912 are in one of SBFD symbols or non-SBFD symbols without the other, without (not allowed to) being applied to configuration type II. In some aspects, UL resource muting may apply to one type of (e.g., and no more than one type of) SBFD symbols or non-SBFD symbols. There may be an indication of symbol type in a UL resource muting information element (IE) in the UL resource muting configuration 910 to indicate the type of symbol that the UL resource muting may be applied to.

In some aspects, UL resource muting may apply to configuration type II where the PUSCH transmission 912 may be in SBFD symbols or non-SBFD symbols, without (not allowed to) being applied to configuration type I. In some aspects, UL resource muting may apply to SBFD symbols or non-SBFD symbols. In some aspects, a single UL muting time and frequency pattern may be configured in the UL resource muting configuration 910 so that the frequency location follows on the PUSCH frequency allocation and frequency offset on SBFD and non-SBFD symbols. In some aspects, two UL muting time and frequency patterns may be separately configured for SBFD and non-SBFD symbols in the UL resource muting configuration 910. The two UL muting time and frequency patterns may have a same pattern, or different patterns.

In some aspects, configuration type I may be applicable to UL resource muting without additional capability indication. In some aspects, the UE may indicate, in a capability reporting (e.g., capability indication 906), whether UL resource muting may be supported when configuration type II is configured. In some aspects, if UL resource muting is supported when configuration type II is configured, two UL muting time and frequency patterns may be separately configured for SBFD and non-SBFD symbols.

In some aspects, for a slot with mixed SBFD and non-SBFD symbols, when UE is provided with configuration type II (e.g., indicated by the network node that network node is associated with) and two UL-RM patterns in the UL resource muting configuration 910, each pattern may be applied separately to a corresponding subset of the symbols in the slot, based on the associated symbol type (e.g., SBFD or non-SBFD). For example, if symbol 0-9 SBFD and symbol1 10-13 non-SBFD, then SBFD UL resource muting pattern is applied to symbols 0-9 and non-SBFD UL resource muting pattern is applied to symbol 10-13. As another example, referring back to FIG. 8B, the SBFD UL resource muting pattern is applied to the SBFD symbol 852, the SBFD symbol 854, the SBFD symbol 858, and the SBFD symbol 860. The non-SBFD UL resource muting pattern is applied to non-SBFD symbol 856.

In some aspects, if UE is provided with configuration type I and a single UL resource muting pattern (e.g., an SBFD UL resource muting pattern) in the UL resource muting configuration 910, then the UL resource muting pattern is applicable to the set of symbols in the slot of the same duplex type.

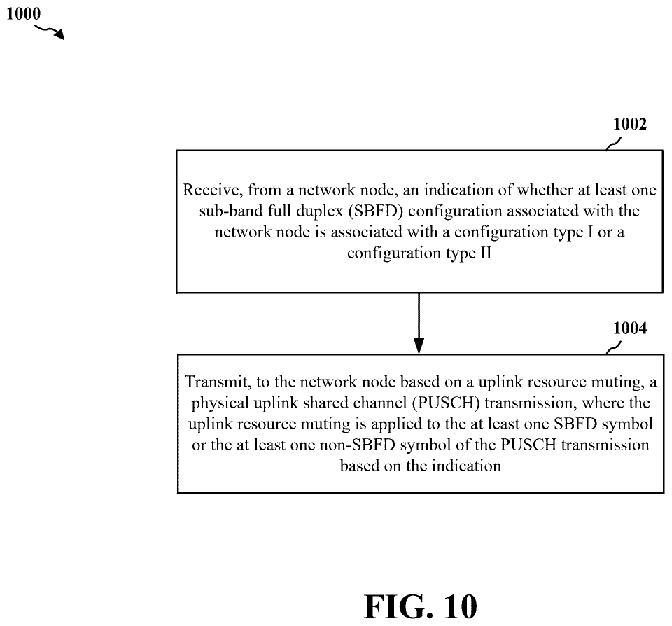

FIG. 10 is a flowchart 1000 of a method of wireless communication. The method may be performed by a UE (e.g., the UE 104; the apparatus 1104). The method may enable signalling mechanisms regarding whether to apply/how to apply UL muting (which may also be referred to as “UL resource muting) on non-SBFD symbols, such as in dynamic TDD scenarios. The method may also enable signalling mechanisms regarding whether to apply/how to apply UL muting for configuration type II. Aspects provided herein may enable more efficient UL muting for mitigating CLI for wireless communication systems.

At 1002, the UE may receive, from a network node, an indication of whether at least one sub-band full duplex (SBFD) configuration associated with the network node (and/or the UE) is associated with a configuration type I or a configuration type II, where the configuration type I is associated with a communication being based on one type of at least one SBFD symbol or at least one non-SBFD symbol without another type, and where the configuration type II is associated with the communication being based on the at least one SBFD symbol and the at least one non-SBFD symbol. For example, the UE 902 may receive, from a network node 904, an indication (e.g., 908) of whether at least one sub-band full duplex (SBFD) configuration associated with the network node (and/or the UE) is associated with a configuration type I or a configuration type II, where the configuration type I is associated with a communication being based on one type of at least one SBFD symbol or at least one non-SBFD symbol without another type, and where the configuration type II is associated with the communication being based on the at least one SBFD symbol and the at least one non-SBFD symbol. In some aspects, 1002 may be performed by SBFD component 198.

At 1004, the UE may transmit, to the network node based on an uplink resource muting, a PUSCH transmission, where the uplink resource muting is applied to the at least one SBFD symbol or the at least one non-SBFD symbol of the PUSCH transmission based on the indication. For example, the UE 902 may transmit, to the network node 904 based on an uplink resource muting, a PUSCH transmission (e.g., 912), where the uplink resource muting is applied to the at least one SBFD symbol or the at least one non-SBFD symbol of the PUSCH transmission based on the indication. In some aspects, 1004 may be performed by SBFD component 198.

In some aspects, the uplink resource muting is applied to the at least one SBFD symbol without being applied to the at least one non-SBFD symbol of the PUSCH transmission regardless of whether the network node (and/or the UE) is associated with the configuration type I or the configuration type II. In some aspects, the uplink resource muting is applied to the at least one SBFD symbol without being applied to the at least one non-SBFD symbol of the PUSCH transmission based on the network node (and/or the UE) being associated with the configuration type I. In some aspects, a valid symbol type associated with the uplink resource muting is SBFD symbol. In some aspects, the uplink resource muting is applied to the at least one SBFD symbol without being applied to the at least one non-SBFD symbol or the at least one non-SBFD symbol without being applied to the at least one SBFD symbol (of the PUSCH transmission) based on the network node (and/or the UE) being associated with the configuration type I. In some aspects, the UE may receive, from the network node, an uplink resource muting configuration (e.g., 910) that indicates whether the uplink resource muting is applied to the at least one SBFD symbol without being applied to the at least one non-SBFD symbol or the at least one non-SBFD symbol without being applied to the at least one SBFD symbol in a symbol type indication in a symbol type indication. In some aspects, the uplink resource muting is applied to the at least one SBFD symbol or the at least one non-SBFD symbol of the PUSCH transmission based on the network node (and/or the UE) being associated with the configuration type II.

In some aspects, the UE may receive, from the network node, an uplink resource muting configuration (e.g., 910) that indicates an uplink muting time and frequency configuration for the at least one SBFD symbol and the at least one non-SBFD symbol. In some aspects, the network node (and/or the UE) is associated with configuration type II, and where for a slot associated with both the at least one SBFD symbol and the at least one non-SBFD symbol, a portion of the slot is associated with the uplink resource muting based on the uplink muting time and frequency configuration. In some aspects, the uplink resource muting configuration indicates that the uplink resource muting is applied to more than one PUSCH occasion in more than one slot (e.g., and in different PUSCH occasions, the uplink resource muting may be applied to different ones of SBFD symbol or non-SBFD symbol). In some aspects, the UE may receive, from the network node, an uplink resource muting configuration (e.g., 910) that indicates a first uplink muting time and frequency configuration for the at least one SBFD symbol and a second uplink muting time and frequency configuration for the at least one non-SBFD symbol.

In some aspects, the UE may transmit, to the network node, a capability indication (e.g., 906) that indicates whether the UE supports the uplink resource muting when the network node (and/or the UE) is associated with configuration type II. In some aspects, the network node (and/or the UE) is associated with configuration type II, and where for a slot associated with both the at least one SBFD symbol and the at least one non-SBFD symbol, a first portion of the slot is associated with the uplink resource muting based on the first uplink muting time and frequency configuration and a second portion of the slot is associated with the uplink resource muting based on the second uplink muting time and frequency configuration.

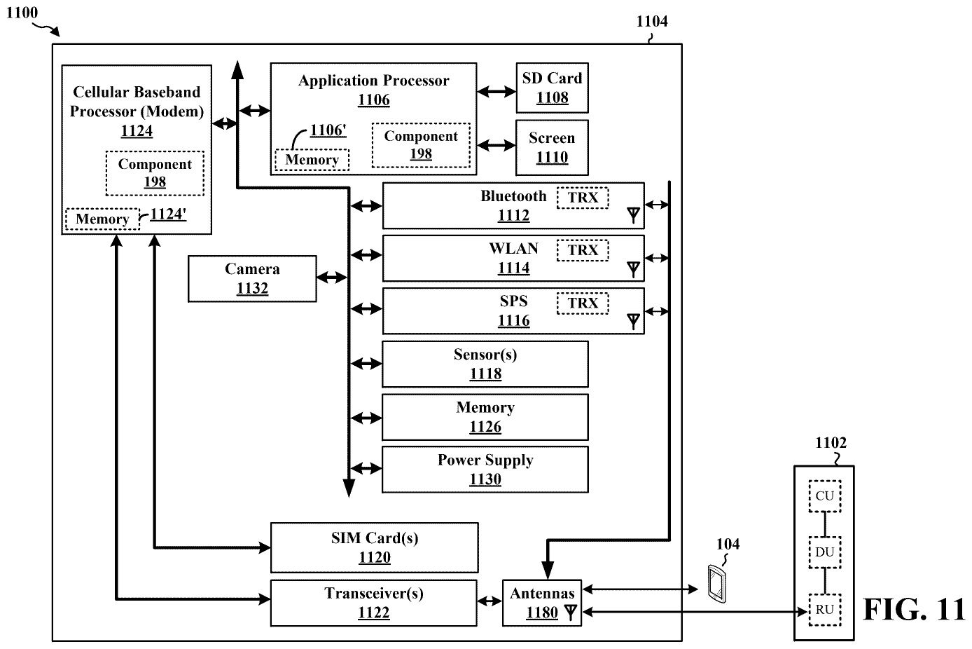

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include at least one cellular baseband processor 1124 (also referred to as a modem) coupled to one or more transceivers 1122 (e.g., cellular RF transceiver). The cellular baseband processor(s) 1124 may include at least one on-chip memory 1124′. In some aspects, the apparatus 1104 may further include one or more subscriber identity modules (SIM) cards 1120 and at least one application processor 1106 coupled to a secure digital (SD) card 1108 and a screen 1110. The application processor(s) 1106 may include on-chip memory 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize the antennas 1180 for communication. The cellular baseband processor(s) 1124 communicates through the transceiver(s) 1122 via one or more antennas 1180 with the UE 104 and/or with an RU associated with a network entity 1102. The cellular baseband processor(s) 1124 and the application processor(s) 1106 may each include a computer-readable medium/memory 1124′, 1106′, respectively. The additional memory modules 1126 may also be considered a computer-readable medium/memory. Each computer-readable medium/memory 1124′, 1106′, 1126 may be non-transitory. The cellular baseband processor(s) 1124 and the application processor(s) 1106 are each responsible for general processing, including the execution of software stored on the computer-readable medium/memory. The software, when executed by the cellular baseband processor(s) 1124/application processor(s) 1106, causes the cellular baseband processor(s) 1124/application processor(s) 1106 to perform the various functions described supra. The computer-readable medium/memory may also be used for storing data that is manipulated by the cellular baseband processor(s) 1124/application processor(s) 1106 when executing software. The cellular baseband processor(s) 1124/application processor(s) 1106 may be a component of the UE 350 and may include the at least one memory 360 and/or at least one of the TX processor 368, the RX processor 356, and the controller/processor 359. In one configuration, the apparatus 1104 may be at least one processor chip (modem and/or application) and include just the cellular baseband processor(s) 1124 and/or the application processor(s) 1106, and in another configuration, the apparatus 1104 may be the entire UE (e.g., see UE 350 of FIG. 3) and include the additional modules of the apparatus 1104.

As discussed supra, the SBFD component 198 may be configured to receive, from a network node, an indication of whether at least one sub-band full duplex (SBFD) configuration associated with the network node (and/or the UE) is associated with a configuration type I or a configuration type II, where the configuration type I is associated with a communication being based on one type of at least one SBFD symbol or at least one non-SBFD symbol without another type, and where the configuration type II is associated with the communication being based on the at least one SBFD symbol and the at least one non-SBFD symbol. In some aspects, the SBFD component 198 may be further configured to transmit, to the network node based on an uplink resource muting, a physical uplink shared channel (PUSCH) transmission, where the uplink resource muting is applied to the at least one SBFD symbol or the at least one non-SBFD symbol of the PUSCH transmission based on the indication. The SBFD component 198 may be within the cellular baseband processor(s) 1124, the application processor(s) 1106, or both the cellular baseband processor(s) 1124 and the application processor(s) 1106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1104 may include a variety of components configured for various functions. In one configuration, the apparatus 1104, and in particular the cellular baseband processor(s) 1124 and/or the application processor(s) 1106, may include means for receiving, from a network node, an indication of whether at least one SBFD configuration associated with the network node is a configuration type I or a configuration type II, where the configuration type I is associated with a communication being based on one type of at least one SBFD symbol or at least one non-SBFD symbol without another type, and where the configuration type II is associated with the communication being based on the at least one SBFD symbol and the at least one non-SBFD symbol. In some aspects, the apparatus 1104 may include means for transmitting, to the network node based on an uplink resource muting, a PUSCH transmission, where the uplink resource muting is applied to the at least one SBFD symbol without being applied to the at least one non-SBFD symbol or the at least one non-SBFD symbol without being applied to the at least one SBFD symbol in a symbol type indication based on the indication. In some aspects, the apparatus 1104 may include means for receiving, from the network node, an uplink resource muting configuration that indicates whether the uplink resource muting is applied to the at least one SBFD symbol without being applied to the at least one non-SBFD symbol or the at least one non-SBFD symbol without being applied to the at least one SBFD symbol in a symbol type indication. In some aspects, the apparatus 1104 may include means for receiving, from the network node, an uplink resource muting configuration that indicates an uplink muting time and frequency configuration for the at least one SBFD symbol and the at least one non-SBFD symbol. In some aspects, the apparatus 1104 may include means for receiving, from the network node, an uplink resource muting configuration that indicates a first uplink muting time and frequency configuration for the at least one SBFD symbol and a second uplink muting time and frequency configuration for the at least one non-SBFD symbol. In some aspects, the apparatus 1104 may include means for transmitting, to the network node, a capability indication that indicates whether the UE supports the uplink resource muting when the network node (and/or the UE) is associated with configuration type II. The means may be the component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S & F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is an apparatus for wireless communication at a user equipment (UE), including: at least one memory; and at least one processor coupled to the at least one memory and, based at least in part on information stored in the at least one memory, the at least one processor is configured to: receive, from a network node, an indication of whether at least one sub-band full duplex (SBFD) configuration associated with the network node (and/or the UE) is associated with a configuration type I or a configuration type II, where the configuration type I is associated with a communication being based on one type of at least one SBFD symbol or at least one non-SBFD symbol without another type, and where the configuration type II is associated with the communication being based on the at least one SBFD symbol and the at least one non-SBFD symbol; and transmit, to the network node based on an uplink resource muting, a physical uplink shared channel (PUSCH) transmission, where the uplink resource muting is applied to the at least one SBFD symbol or the at least one non-SBFD symbol of the PUSCH transmission based on the indication.

Aspect 2 is the apparatus of aspect 1, where the uplink resource muting is applied to the at least one SBFD symbol without being applied to the at least one non-SBFD symbol of the PUSCH transmission.

Aspect 3 is the apparatus of any of aspects 1-2, where the uplink resource muting is applied to the at least one SBFD symbol without being applied to the at least one non-SBFD symbol of the PUSCH transmission based on the network node (and/or the UE) being associated with the configuration type I that the uplink resource muting is restricted to the at least one SBFD symbol without being applicable to the at least one non-SBFD symbol.

Aspect 4 is the apparatus of any of aspects 1-3, where a valid symbol type associated with the uplink resource muting is SBFD symbol.

Aspect 5 is the apparatus of any of aspects 1-4, where the uplink resource muting is applied to the at least one SBFD symbol without being applied to the at least one non-SBFD symbol or the at least one non-SBFD symbol without being applied to the at least one SBFD symbol based on the UE being associated with the configuration type I.

Aspect 6 is the apparatus of aspect 5, where the at least one processor is further configured to: receive, from the network node, an uplink resource muting configuration that indicates whether the uplink resource muting is applied to the at least one SBFD symbol without being applied to the at least one non-SBFD symbol or the at least one non-SBFD symbol without being applied to the at least one SBFD symbol in a symbol type indication.

Aspect 7 is the apparatus of any of aspects 1-6, where the uplink resource muting is applied to the at least one SBFD symbol and the at least one non-SBFD symbol of the PUSCH transmission based on the UE being associated with the configuration type II.

Aspect 8 is the apparatus of aspect 7, where the at least one processor is further configured to: receive, from the network node, an uplink resource muting configuration that indicates an uplink muting time and frequency configuration for the at least one SBFD symbol and the at least one non-SBFD symbol.

Aspect 9 is the apparatus of aspect 8, where the UE is associated with the configuration type II, and where for a slot associated with both the at least one SBFD symbol and the at least one non-SBFD symbol, a portion of the slot is associated with the uplink resource muting based on the uplink muting time and frequency configuration.

Aspect 10 is the apparatus of any of aspects 8-9, where the uplink resource muting configuration indicates that the uplink resource muting is applied to more than one PUSCH occasion in more than one slot.

Aspect 11 is the apparatus of any of aspects 7-10, where the at least one processor is further configured to: receive, from the network node, an uplink resource muting configuration that indicates a first uplink muting time and frequency configuration for the at least one SBFD symbol and a second uplink muting time and frequency configuration for the at least one non-SBFD symbol.

Aspect 12 is the apparatus of aspect 11, where the at least one processor is further configured to: transmit, to the network node, a capability indication that indicates whether the UE supports the uplink resource muting when the UE is associated with the configuration type II.

Aspect 13 is the apparatus of any of aspects 11-12, where the UE is associated with the configuration type II, and where for a slot associated with both the at least one SBFD symbol and the at least one non-SBFD symbol, a first portion of the slot is associated with the uplink resource muting based on the first uplink muting time and frequency configuration and a second portion of the slot is associated with the uplink resource muting based on the second uplink muting time and frequency configuration.

Aspect 14 is the apparatus of any of aspects 1-13, where the UE is associated with the configuration type II, and where for PUSCH occasions associated with both the at least one SBFD symbol and the at least one non-SBFD symbol in different slots, the PUSCH occasions are associated with the uplink resource muting.

Aspect 15 is a method of wireless communication for implementing any of aspects 1 to 14.

Aspect 16 is a computer-readable medium (e.g., a non-transitory computer-readable medium) storing computer executable code, the code when executed by at least one processor causes the at least one processor to implement any of aspects 1 to 14.

Aspect 17 is an apparatus comprising means for implementing any of aspects 1 to 14.

Aspect 18 is an apparatus for wireless communication at a network node, including: at least one memory; and at least one processor coupled to the at least one memory and, based at least in part on information stored in the at least one memory, the at least one processor is configured to: transmit, for a UE, an indication of whether at least one sub-band full duplex (SBFD) configuration associated with the network node (and/or the UE) is associated with a configuration type I or a configuration type II, where the configuration type I is associated with a communication being based on one type of at least one SBFD symbol or at least one non-SBFD symbol without another type, and where the configuration type II is associated with the communication being based on the at least one SBFD symbol and the at least one non-SBFD symbol; and receive, from the UE based on an uplink resource muting, a physical uplink shared channel (PUSCH) transmission, where the uplink resource muting is applied to the at least one SBFD symbol or the at least one non-SBFD symbol of the PUSCH transmission based on the indication.

Aspect 19 is the apparatus of aspect 18, where the uplink resource muting is applied to the at least one SBFD symbol without being applied to the at least one non-SBFD symbol of the PUSCH transmission.

Aspect 20 is the apparatus of any of aspects 18-19, where the uplink resource muting is applied to the at least one SBFD symbol without being applied to the at least one non-SBFD symbol of the PUSCH transmission based on the network node (and/or the UE) being associated with the configuration type I that the uplink resource muting is restricted to the at least one SBFD symbol without being applicable to the at least one non-SBFD symbol.

Aspect 21 is the apparatus of any of aspects 18-20, where a valid symbol type associated with the uplink resource muting is SBFD symbol.

Aspect 22 is the apparatus of any of aspects 18-21, where the uplink resource muting is applied to the at least one SBFD symbol without being applied to the at least one non-SBFD symbol or the at least one non-SBFD symbol without being applied to the at least one SBFD symbol based on the UE being associated with the configuration type I.

Aspect 23 is the apparatus of aspect 22, where the at least one processor is further configured to: transmit, for the UE, an uplink resource muting configuration that indicates whether the uplink resource muting is applied to the at least one SBFD symbol without being applied to the at least one non-SBFD symbol or the at least one non-SBFD symbol without being applied to the at least one SBFD symbol in a symbol type indication.

Aspect 24 is the apparatus of any of aspects 18-23, where the uplink resource muting is applied to the at least one SBFD symbol and the at least one non-SBFD symbol of the PUSCH transmission based on the UE being associated with the configuration type II.

Aspect 25 is the apparatus of aspect 24, where the at least one processor is further configured to: transmit, for the UE, an uplink resource muting configuration that indicates an uplink muting time and frequency configuration for the at least one SBFD symbol and the at least one non-SBFD symbol.

Aspect 26 is the apparatus of aspect 25, where the UE is associated with the configuration type II, and where for a slot associated with both the at least one SBFD symbol and the at least one non-SBFD symbol, a portion of the slot is associated with the uplink resource muting based on the uplink muting time and frequency configuration.

Aspect 27 is the apparatus of any of aspects 25-26, where the uplink resource muting configuration indicates that the uplink resource muting is applied to more than one PUSCH occasion in more than one slot.

Aspect 28 is the apparatus of any of aspects 25-27, where the at least one processor is further configured to: transmit, for the UE, an uplink resource muting configuration that indicates a first uplink muting time and frequency configuration for the at least one SBFD symbol and a second uplink muting time and frequency configuration for the at least one non-SBFD symbol.

Aspect 29 is the apparatus of aspect 28, where the at least one processor is further configured to: receive, from the UE, a capability indication that indicates whether the UE supports the uplink resource muting when the UE is associated with the configuration type II.

Aspect 30 is the apparatus of any of aspects 28-29, where the UE is associated with the configuration type II, and where for a slot associated with both the at least one SBFD symbol and the at least one non-SBFD symbol, a first portion of the slot is associated with the uplink resource muting based on the first uplink muting time and frequency configuration and a second portion of the slot is associated with the uplink resource muting based on the second uplink muting time and frequency configuration.

Aspect 31 is the apparatus of any of aspects 18-30, where the UE is associated with the configuration type II, and where for PUSCH occasions associated with both the at least one SBFD symbol and the at least one non-SBFD symbol in different slots, the PUSCH occasions are associated with the uplink resource muting.

Aspect 32 is a method of wireless communication for implementing any of aspects 18 to 31.

Aspect 33 is a computer-readable medium (e.g., a non-transitory computer-readable medium) storing computer executable code, the code when executed by at least one processor causes the at least one processor to implement any of aspects 18 to 31.

Aspect 34 is an apparatus comprising means for implementing any of aspects 18 to 31.

What is claimed is:

1. An apparatus for wireless communication at a user equipment (UE), comprising:
at least one memory; and
at least one processor coupled to the at least one memory and, based at least in part on information stored in the at least one memory, the at least one processor is configured to:
receive, from a network node, an indication of whether at least one sub-band full duplex (SBFD) configuration associated with the network node is associated with a configuration type I or a configuration type II, wherein the configuration type I is associated with a communication being based on one type of at least one SBFD symbol or at least one non-SBFD symbol without another type, and wherein the configuration type II is associated with the communication being based on the at least one SBFD symbol and the at least one non-SBFD symbol;
receive, from the network node, an uplink resource muting configuration that comprises an information element (IE) that indicates whether uplink resource muting is applicable for non-SBFD symbols; and
transmit, to the network node based on the uplink resource muting, a physical uplink shared channel (PUSCH) transmission, wherein the uplink resource muting is applied to the at least one SBFD symbol or the at least one non-SBFD symbol of the PUSCH transmission based on the indication and the IE.

2. The apparatus of claim 1, wherein the uplink resource muting is applied to the at least one SBFD symbol without being applied to the at least one non-SBFD symbol of the PUSCH transmission.

3. The apparatus of claim 1, wherein the uplink resource muting is applied to the at least one SBFD symbol without being applied to the at least one non-SBFD symbol of the PUSCH transmission based on at least one of the network node or the UE being associated with the configuration type I that the uplink resource muting is restricted to the at least one SBFD symbol without being applicable to the at least one non-SBFD symbol.

4. The apparatus of claim 1, wherein a valid symbol type associated with the uplink resource muting is an SBFD symbol.

5. The apparatus of claim 1, wherein the uplink resource muting is applied, based on the UE being associated with the configuration type I, to:
the at least one SBFD symbol without being applied to the at least one non-SBFD symbol, or
the at least one non-SBFD symbol without being applied to the at least one SBFD symbol.

6. The apparatus of claim 5, wherein the uplink resource muting configuration indicates whether the uplink resource muting is applied to the at least one non-SBFD symbol without indicating the at least one SBFD symbol in a symbol type indication.

7. The apparatus of claim 1, wherein the uplink resource muting is applied to the at least one SBFD symbol and the at least one non-SBFD symbol of the PUSCH transmission based on the UE being associated with the configuration type II.

8. The apparatus of claim 7, wherein the uplink resource muting configuration indicates whether the uplink resource muting is applied to the at least one non-SBFD symbol without indicating the at least one SBFD symbol in a symbol type indication.

9. The apparatus of claim 8, wherein the UE is associated with the configuration type II, and wherein for a slot associated with both the at least one SBFD symbol and the at least one non-SBFD symbol, a portion of the slot is associated with the uplink resource muting based on the uplink resource muting configuration.

10. The apparatus of claim 8, wherein the UE is associated with the configuration type II, and wherein for PUSCH occasions associated with both the at least one SBFD symbol and the at least one non-SBFD symbol in different slots, the PUSCH occasions are associated with the uplink resource muting.

11. The apparatus of claim 8, wherein the uplink resource muting configuration indicates that the uplink resource muting is applied to more than one PUSCH occasion in more than one slot.

12. The apparatus of claim 7, wherein the uplink resource muting configuration indicates a first uplink muting time and frequency configuration for the at least one SBFD symbol and a second uplink muting time and frequency configuration for the at least one non-SBFD symbol.

13. The apparatus of claim 12, further comprising:
a transceiver coupled to the at least one processor, wherein the at least one processor is further configured to:
transmit, to the network node via the transceiver, a capability indication that indicates whether the UE supports the uplink resource muting when the UE is associated with the configuration type II.

14. The apparatus of claim 12, wherein the UE is associated with the configuration type II, and wherein for a slot associated with both the at least one SBFD symbol and the at least one non-SBFD symbol, a first portion of the slot is associated with the uplink resource muting based on the first uplink muting time and frequency configuration and a second portion of the slot is associated with the uplink resource muting based on the second uplink muting time and frequency configuration.

15. The apparatus of claim 14, wherein the UE is associated with the configuration type II, and wherein for PUSCH occasions associated with both the at least one SBFD symbol and the at least one non-SBFD symbol in different slots, the PUSCH occasions are associated with the uplink resource muting.

16. A method of wireless communication performed by a user equipment (UE), comprising:
receiving, from a network node, an indication of whether at least one sub-band full duplex (SBFD) configuration associated with the network node is associated with a configuration type I or a configuration type II, wherein the configuration type I is associated with a communication being based on one type of at least one SBFD symbol or at least one non-SBFD symbol without another type, and wherein the configuration type II is associated with the communication being based on the at least one SBFD symbol and the at least one non-SBFD symbol;
receiving, from the network node, an uplink resource muting configuration that comprises an information element (IE) that indicates whether uplink resource muting is applicable for non-SBFD symbols; and
transmitting, to the network node based on the uplink resource muting, a physical uplink shared channel (PUSCH) transmission, wherein the uplink resource muting is applied to the at least one SBFD symbol or the at least one non-SBFD symbol of the PUSCH transmission based on the indication and the IE.

17. The method of claim 16, wherein the uplink resource muting is applied to the at least one SBFD symbol without being applied to the at least one non-SBFD symbol of the PUSCH transmission.

18. The method of claim 16, wherein the uplink resource muting is applied to the at least one SBFD symbol without being applied to the at least one non-SBFD symbol of the PUSCH transmission based on the network node being associated with the configuration type I that the uplink resource muting is restricted to the at least one SBFD symbol without being applicable to the at least one non-SBFD symbol.

19. An apparatus for wireless communication at a network node, comprising:
at least one memory; and
at least one processor coupled to the at least one memory and, based at least in part on information stored in the at least one memory, the at least one processor is configured to:
transmit an indication of whether at least one sub-band full duplex (SBFD) configuration associated with the network node is associated with a configuration type I or a configuration type II, wherein the configuration type I is associated with a communication being based on one type of at least one SBFD symbol or at least one non-SBFD symbol without another type, and wherein the configuration type II is associated with the communication being based on the at least one SBFD symbol and the at least one non-SBFD symbol;
transmit an uplink resource muting configuration that comprises an information element (IE) that indicates whether uplink resource muting is applicable for non-SBFD symbols; and
receive a physical uplink shared channel (PUSCH) transmission from a user equipment (UE), wherein the uplink resource muting is applied to the at least one SBFD symbol or the at least one non-SBFD symbol of the PUSCH transmission based on the indication and the IE.

20. The apparatus of claim 19, wherein the uplink resource muting is applied to the at least one SBFD symbol and not the at least one non-SBFD symbol of the PUSCH transmission.
